(19) United States
(12) Patent Application Publication
(10) Pub. No.: US 2015/0095102 A1
(43) Pub. Date: Apr. 2, 2015

(54) COMPUTER IMPLEMENTED SYSTEM AND METHOD FOR ENSURING COMPUTER INFORMATION TECHNOLOGY INFRASTRUCTURE CONTINUITY

(71) Applicant: Neverfail Group Limited, Theale (GB)

(72) Inventors: Douglas Hanley, Edinburgh (GB); Ashwin Kotian, Cedar Park, TX (US); Nick Harmer, Wiltshire (GB); Kelvin Clibbon, Hampshire (GB)

(21) Appl. No.: 14/500,639

(22) Filed: Sep. 29, 2014

Related U.S. Application Data
(60) Provisional application No. 61/884,481, filed on Sep. 30, 2013.

(51) Int. Cl. G06Q 10/06; H04L 29/06; H04L 12/26

(52) U.S. Cl. CPC G06Q 10/0635; H04L 43/08; H04L 63/1433
USPC 705/7.28

(57) ABSTRACT

The present invention relates to a system computer implemented information technology (“IT”) management solution that bridges the gap between deployed computer information technology infrastructure and business services to determine what information technology a business entity or other organization currently has, what is at risk and what is needed to assure IT infrastructure continuity.

The present system and method of use is a computer implemented information technology (“IT”) management solution that bridges the gap between deployed computer information technology infrastructure and business services to determine what information technology a business entity or other organization currently has, what is at risk and what is needed to assure IT infrastructure continuity. This application claims the benefit of U.S. Provisional Application No. 61/884,481, filed on Sep. 30, 2013.

### BACKGROUND

The use of computers has become vital to the operations of government, business, and military operations. Loss of computer availability can disrupt operations resulting in degraded services, loss of revenue, and even risk of human casualty.

For example, disruption of financial systems, electronic messaging, mobile communications, and internet sales sites can result in loss of revenue. Disruption of an industrial process control system or health care system may result in loss of life in addition to loss of revenue. Disruption of government systems can lead to lack of vital services being available to users. Some applications can accommodate an occasional error or short delay but otherwise require high availability, continuous availability or fault tolerance of a computer system. Other applications, such as air traffic control and nuclear power generation, may incur a high cost in terms of human welfare and property destruction when computers are not available to perform the intended processing purpose.

While computer systems have traditionally consisted of physical machines (computers), with the use of virtual machines (computers, servers and the like), IT infrastructure has become more agile and fault tolerant than ever. A virtual machine is a software implementation of a machine (i.e. a computer) that simulates a physical machine and executes computer software instructions like a physical computer.

Although a physical machine host is required for implementation of one or more virtual machines, virtualization permits consolidation of computing resources otherwise distributed across multiple physical machines to fewer or even a single host physical machine. The consolidation enables reductions in space, power, cooling, and hardware requirements. A virtual machine can be moved between physical machines to balance workloads, utilize faster physical machines, or to recover from a hardware fault on a physical machine. The benefits of virtualization have resulted in the development of virtual machine management tools.

While the use of virtualization can lead to reductions in the cost of deploying and managing computers, the inability to use the same management tool to manage all of the individual machines forming the computer system as a whole tends to increase the cost and complexity of managing the system as a whole.

Even though virtualization has made it easier to protect individual virtual machines (VMs), it is harder than ever to assure that protection will work as intended across complex business services. IT Infrastructure and Operations (I&O) professionals and their IT organizations face at least the following fundamental challenges:
Virtualization has hidden costs. With virtual infrastructure, workloads can be deployed or relocated quickly. Yet an accurate, up-to-date and easy-to-interpret blueprint of what software applications, virtual machines and physical machines live where, who uses them, and what dependencies (known and unknown) exist with other applications, VMs and hosts isn't provided. Agility may unravel protection strategies without prior warning because the overall blueprint doesn't exist. IT I&O organizations lack clear visibility into how the IT infrastructure maps to business services and whether availability service level targets can be met.
Adapting to constant datacenter changes. In a modern datacenter, the infrastructure is changing constantly. New virtual machines may put additional load on the infrastructure, or configuration changes may impact components that are vital to a business service. Without a current blueprint of your IT assets and their inter-dependencies, the full impact of a load, configuration or other change can't be understood. What appears to be a relatively unimportant change to the infrastructure might turn out to unknowingly be catastrophic when a critically important application or component fails.
Knowing whether business continuity and disaster recovery plans will work. Companies increasingly rely on IT, so business operations can come to a halt in an outage—but it turns out this is complicated. Business services are composed of distributed application components running on multiple platforms—virtual, physical, different operating systems or hypervisors—that in turn depend on multiple protection technologies. As used herein, a hypervisor is a virtualization manager software program that allows multiple software operating systems to share a single computer hardware host by controlling the host computer processor and resources, allocating processor and other resources to each operating system and making sure that the virtual machines can't disrupt each other. How will the recovery of an entire business service within service level targets be planned for and then assured over time, given heterogeneous protection infrastructure and constant change?

Therefore, a gap exists between IT's business continuity readiness and its organization's expectations for service availability. IT sees disaster recovery and business continuity in terms of the infrastructure that they manage, patch, backup and protect, but lack insight into how the infrastructure ties to business services. The business just expects IT to figure out how to keep it running. As a result IT takes the brunt of the blame for any outage with little support for implementing proper strategies and solutions to protect the business from downtime. IT infrastructure and IT continuity need to be managed from the perspective that really matters: that of the consumers of the business services, meaning the end-user customer, whether internal or external to the organization.

### SUMMARY

The present computer implemented system and method provides clear visibility across the entire IT infrastructure by automatically analyzing computer IT infrastructure, mapping dependencies and tracking changes. Key features include:

Computer Automated Infrastructure and Dependency Discovery: Identifies IT infrastructure components and provides a map of dependencies between computer software applications, hypervisors, computer servers and other inventory objects, giving the IT department insight in to the impact of any potential changes in the IT infrastructure.

Business Services Mapping: Aggregates IT infrastructure and applications into groups based on their interdependencies so users can easily define business services and visualize the IT infrastructure supporting each service.

Define Business Continuity Targets: Provides four service level tiers that users can customize to define their own targets and then assign each business service to the appropriate tier. The system automatically reports on any gaps or misconfigurations of protection infrastructure.

Risk Identification Heat Maps: Helps IT intelligently prioritize remediation efforts based on risk. From the analysis of established availability service level tiers and the number of key dependencies, the system's heat maps show which servers are the most critical to business continuity.

Availability Monitoring and Reporting: Provides ongoing and continuous monitoring, assurance and reporting of service level compliance.

The present computer implemented system and method bridges the gap between IT infrastructure and business services so IT departments can trust their business continuity plans will consistently work. The system automatically analyzes IT infrastructure, maps dependencies and tracks changes, to determine what IT is at risk and what a business needs to do to assure IT continuity without failure. By letting IT departments set recovery time objectives (“RTO”) and recovery point objectives (“RPO”) by application, the present system allows businesses to decrease the risk of IT outages, reduce the cost of disaster recovery infrastructure, maintain compliance with service level commitments and avoid computer IT downtime. It helps avoid downtime as efficiently and effectively as possible, even in the largest and most dynamic of environments. As used herein a Recovery Point Objective represents the amount of data loss that a system can tolerate. As used herein, a Recovery Time Objective is a measure of the allowable downtime for a computer system after a fault.

The system works through a simple and streamlined process, beginning with deployment:

Packaging and Deployment. In one embodiment, the present system is packaged as a virtual machine (also called a virtual appliance) that is designed to run on a computer physical hardware or a virtual system. As used herein, a virtual appliance is a system that composed of a software application (such as server software) having just enough operating system software to run optimally on industry standard computer hardware or a computer virtual machine.

The present computer implemented system and method provides clear visibility across the entire IT infrastructure by automatically analyzing computer IT infrastructure, mapping dependencies and tracking changes. Key features include:

Computer Automated Infrastructure and Dependency Discovery: identifies IT infrastructure components and provides a map of dependencies between computer software applications, hypervisors, computer servers and other inventory objects, giving the IT department insight in to the impact of any potential changes in the IT infrastructure.

Business Services Mapping: Aggregates IT infrastructure and applications into groups based on their interdependencies so users can easily define business services and visualize the IT infrastructure supporting each service.

Define Business Continuity Targets: Provides four service level tiers that users can customize to define their own targets and then assign each business service to the appropriate tier. The system automatically reports on any gaps or misconfigurations of protection infrastructure.

Risk Identification Heat Maps; Helps IT intelligently prioritize remediation efforts based on risk. From the analysis of established availability service level tiers and the number of key dependencies, the system's heat maps show which servers are the most critical to business continuity.

Availability Monitoring and Reporting: Provides ongoing and continuous monitoring, assurance and reporting of service level compliance.

The present system and method is complementary to existing system and operation's management tools by connecting business services to underlying IT infrastructure that may be managed by existing system and operation's management tools to enable IT to understand dependencies across the infrastructure, including networks, virtual and physical servers as well as applications and business services to analyze their inter-dependencies, and identifies risks around any critical IT components impacting the organization's IT continuity plans. The present system and method solves at least the following problems by delivering as an end result: (i) an inventory of IT infrastructure, computers, servers, software applications, all physical and virtual machines and how all of the above is interconnected that may be displayed to a user; (ii) the details of how the inventory and interconnections set forth in (i) above are connected to the business services that the IT infrastructure supports; and (iii) the details of how (and if) critical IT infrastructure and the business services they support are protected to provide business continuity and disaster recovery. The end results of the computer processing of the present computer implemented system and software method provides a holistic topology of the IT components (physical machines, virtual machines, software applications and the like), how those component support the business services and where risks of critical points of IT component or system failure may be as well business continuity and disaster recovery IT infrastructure plans that can mitigate the risks of IT component or system failure.

### BRIEF DESCRIPTION OF DRAWINGS

These and other features, aspects and advantages of the present invention will become better understood with regard to the following description, appended claims, and accompanying drawings wherein:

FIG. 1 depicts a computer system and network suitable for implementing the system and method for ensuring computer information technology infrastructure continuity.

FIG. 2 is a logical architecture block diagram illustrating one embodiment of the functions of the computer implemented system and method for ensuring computer information technology infrastructure continuity.

FIG. 3 is a depiction of one embodiment of a user interface of the present system.

FIGS. 4A and 4B are depictions of one embodiment of the workflow of the present system for the automated infrastructure and dependency discovery module.

FIG. 5 is a diagram representative of the discovery, fingerprinting and blueprinting process.

FIG. 6 is a depiction of one embodiment of the graphical user interface rendering of the status of discovery and analysis of the present system.

FIG. 7 is a depiction of one embodiment of the graphical user interface heatmap of the present system

FIG. 8 is a depiction of an exemplary system dependency graph of the present system.

FIG. 9 is a depiction of a user interface of an exemplary business service of the present system.

FIG. 10 is a depiction of a user interface of an exemplary protection tier settings display.

FIG. 11 shows the protection assessment that is a visual depiction of exemplary health summary of the status of the IT continuity infrastructure.

FIG. 12 is a visual depiction of a user interface showing exemplary infrastructure change monitoring functionality of the present system.

FIG. 13 is a visual depiction of a user interface showing exemplary recovery point monitoring functionality of the present system.

FIG. 14 is a visual depiction of a user interface showing exemplary availability monitoring functionality of the present system.

FIG. 15 depicts an alternative embodiment of a computer system and network suitable for implementing the system and method for ensuring computer information technology infrastructure continuity.

### DETAILED DESCRIPTION OF INVENTION

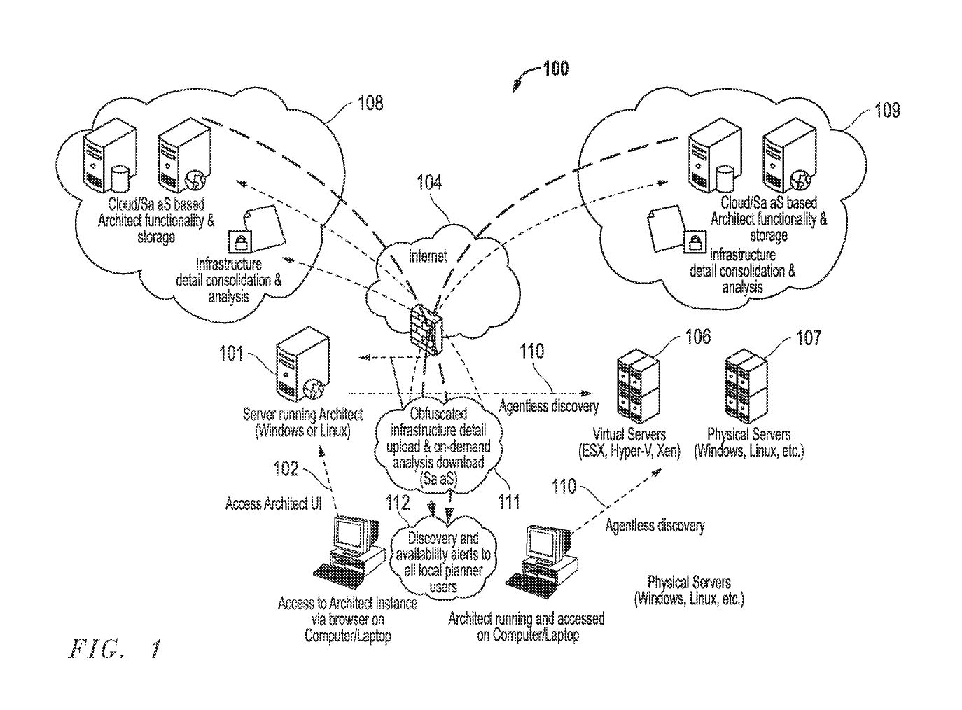

FIG. 1 depicts a computer system and network 100 suitable for implementing the system and method for ensuring computer information technology infrastructure continuity.

A server computer 101 includes an operating system for controlling the overall operation of the server (this is also known as the architect server appliance), which connects to user interface devices 102 via a communication network 104. The system (also known as “architect” or “architect server”) comprises a software-implemented application that is deployed and resides in a server (physical or virtual) hypervisor 108, 109. The system connects to virtual server services 106 and physical server services 107 that may be running a variety of hypervisors and operating systems. A user interface is accessible via a web browser through a network such as the Internet 104 or proprietary network. The system scans a network 104 for live server/computer hosts and operating systems. The system also scans open ports on machines for applications. Storage devices connected to the system are also identified and discovered. The system's discovery is agentless 110. Hosts 106, 107 may be scanned remotely using windows management instrumentation (for example WMI or Netstat) to provide an operating system interface through which components provide information about themselves and their status and notification 112. The system also sniffs packets on the network, looking for new networks, new computers and application dependencies 111.

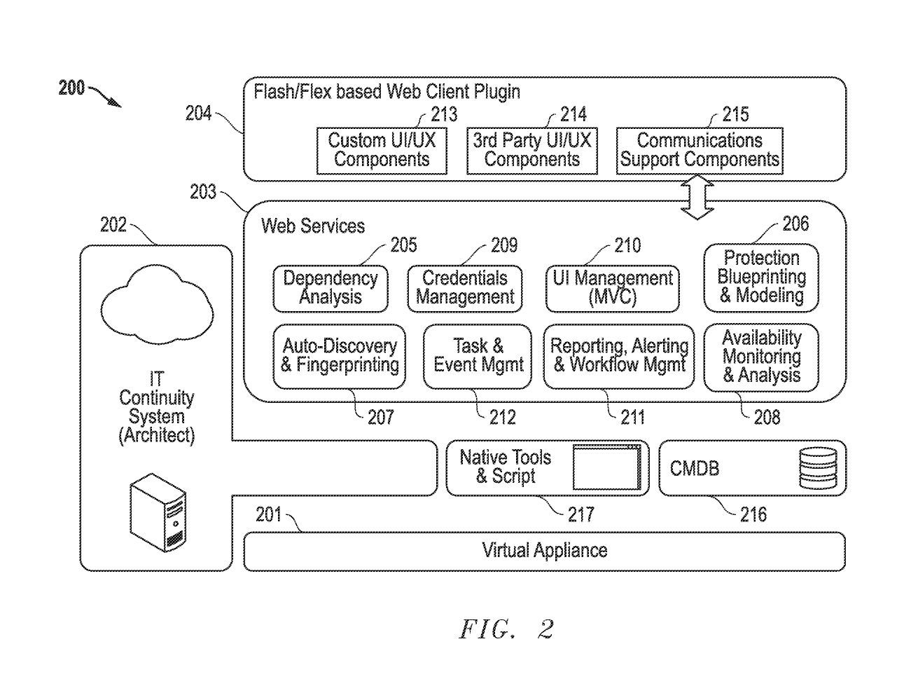

FIG. 2 is a logical architecture block diagram 200 illustrating one embodiment of the functions of the computer implemented system and method for ensuring computer information technology infrastructure continuity.

The present system 202 comprises a server virtual appliance for rapid deployment and a management user interface web client plug-in 204. The system 202 is packaged and runs as a virtual appliance 201. The system scans 202 networks and operating systems for hosts. The system also uses active directory services to identify hosts. The system uses agentless discovery to scan the hosts remotely using WMI and Netstat. The system uses packet sniffing, and native tools and scripts; to identify applications on hosts. The system uses web-services 203 to (a) conduct application dependency analysis 205; (b) blueprint and model the applications to be protected 206; (c) conduct discovery and application fingerprinting 207; (d) monitor the protected applications and analyze issues 208; (e) manage credentials for auto-discovery and application mapping 209; (f) manage the user interface, tasks and events 210; (g) monitor tasks and manage events 212 (and h) reporting and alerting 211. The user interface 213, 214 may be a web-client plug-in (such as Flash/Flex) 204, accessible via a web-browser and may have communication support components 215. The systems configuration data is stored in a configuration management data base (CMDB) 216. Native tools and scripts are also used 217.

The deployment process involves an open virtual appliance import. During deployment, the virtual appliance asks for minimal configuration information about the user's IT environment in the form of server name or IP to register with and associated administrator credentials. The selection of “host network” that the virtual appliance is configured with during the open virtual appliance deployment determines the initial scope and network boundary for virtual appliance to perform discovery until some level of further analysis has been completed. Immediately upon deployment, the virtual appliance begins to discover entities within its host network and starts to perform an initial assessment using the server credentials provided.

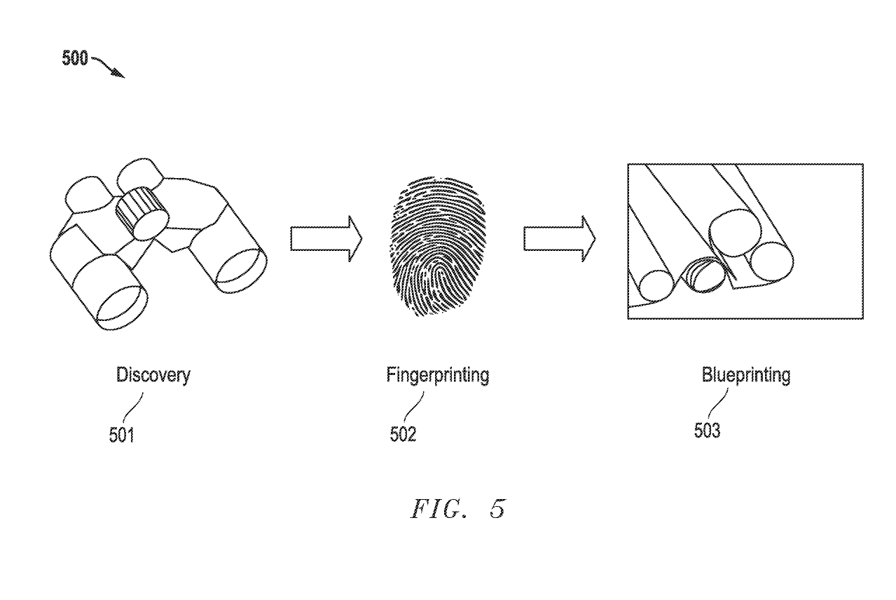

The auto discovery (agentless) and fingerprinting function of the virtual appliance uses network technology for discovery and fingerprinting and blueprinting and modeling as described in more detail below for FIG. 5. Since the “discovery phase” of the virtual appliance sets the tone for ensuring accurate capture and quick analysis of an IT environment, the choice of deployment target in terms of the host and server instance to register with is an important decision point. The host target is important to ensure the most optimal “host network” is available for initial discovery while the server selection determines how expansive or restrictive is the discovery of server inventory.

If the virtual appliance is deployed with a production server running on a production network, the virtual appliance will be able to immediately discover and report the most critical IT assets and their interdependencies. In this scenario, the virtual appliance wouldn't need to perform network-based discovery for building the inventory of virtual infrastructure because it would obtain all necessary information via its integration with the other server application APIs.

If the virtual appliance is deployed in a more conservative deployment strategy of registering the virtual appliance with a test/development server environment, the initial discovery process may be limited to non-critical inventory until the virtual appliance performs further analysis to discover other production networks and capture production inventory via the network-based discovery process. Optionally, the discovery and analysis process can be accelerated by manually adding production networks and associated credentials for discovery and analysis.

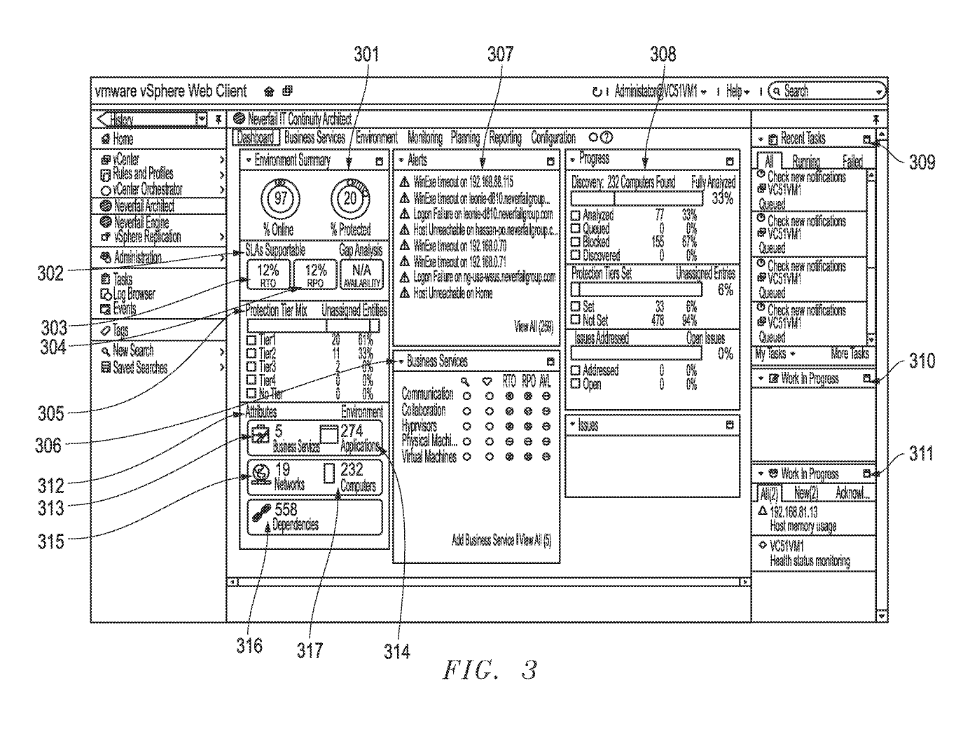

FIG. 3 is a depiction of one embodiment of a user interface 300 of the present system. The system (architect) display shows an environment summary 301 that shows the status of the networked computer information technology infrastructure. Within the environment summary 301 is a display of the service level supported 302, the recovery time objectives 303 and recovery point objectives 304 of the system. The networked computers are grouped into service level tiers 305 and the display shows the number of computers that are in each tier and each tier's percentage of the overall networked computer information technology infrastructure. In the embodiment shown, the business services 306 examples include the following business services: communication; collaboration; hypervisors, physical machines and virtual machines. Each of the services shown has a status, lists RTO and RPO and availability 306. The RTO displays the current likelihood of the business service achieving the configured RTO based upon the system's monitoring. For example, an RTO displaying green indicates that there is protection technology in place for the particular business service (or aggregate of all business services) and appears able to meet the assigned SLA; amber means that a protection technology in place for the particular business service (or aggregate of all business services) and appears not to be configured to meet the assigned SLA; red means that no protections for the particular business service were discovered; and gray means that a protection tier or technology hasn't yet been assigned or the analysis of entities is not complete. Similarly, an RPO displaying green indicates that there is protection technology in place for the particular business service (or aggregate of all business services) and appears able to meet the assigned SLA; amber means that a protection technology in place for the particular business service (or aggregate of all business services) and appears not to be configured to meet the assigned SLA; red means that no protections for the particular business service were discovered; and gray means that a protection tier or technology hasn't yet been assigned or the analysis of entities is not complete.

Alerts 307 regarding the status of the networked computer information technology infrastructure are displayed. The discovery process and progress 308 is also displayed. This display 308 shows the number of computers found on the network (and the number analyzed, queued, blocked and discovered, the number of protection tiers set and the status of any issues (problems) addressed or open. Attributes of the networked computer information technology infrastructure are displayed 312. In this embodiment the attributes 312 include business services 313, networks that are part of the system 315, the number of applications in the system 314, the number of computers in the networked computer information technology infrastructure 317 and the number of dependencies 316 in the networked computer information technology infrastructure.

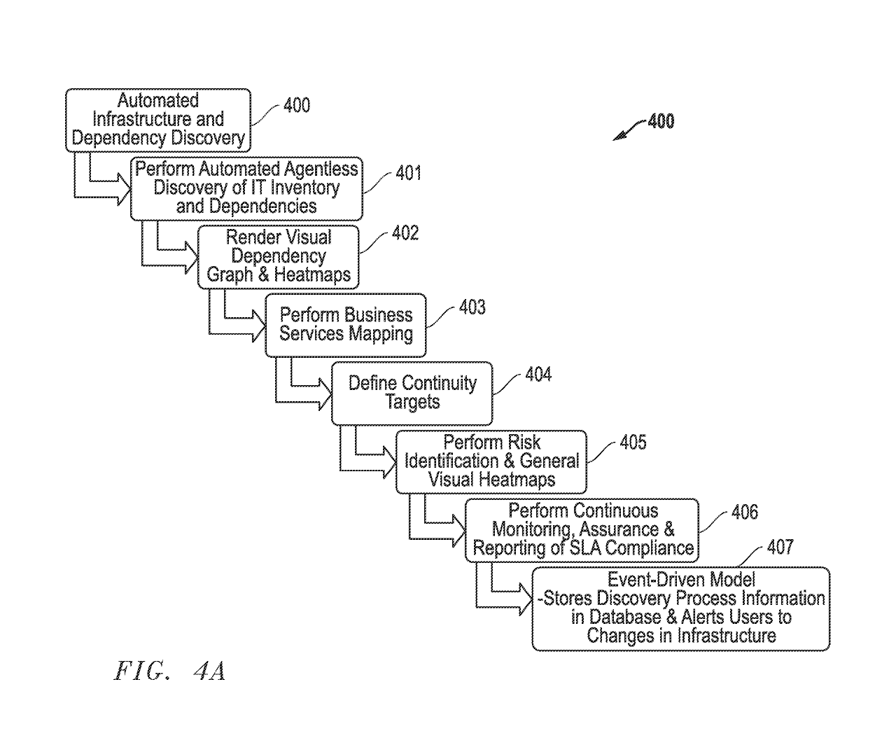

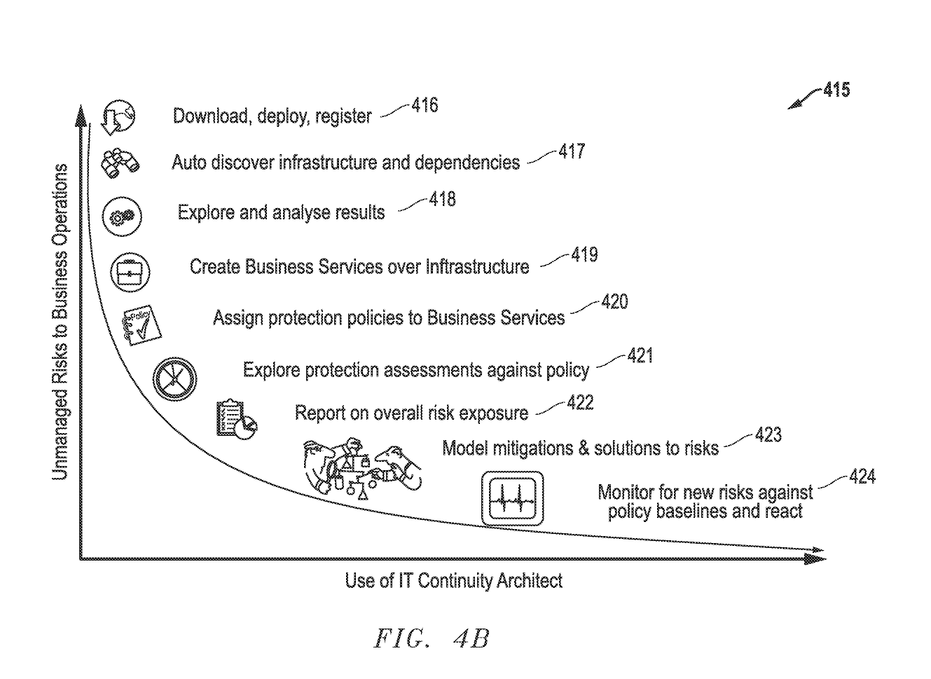

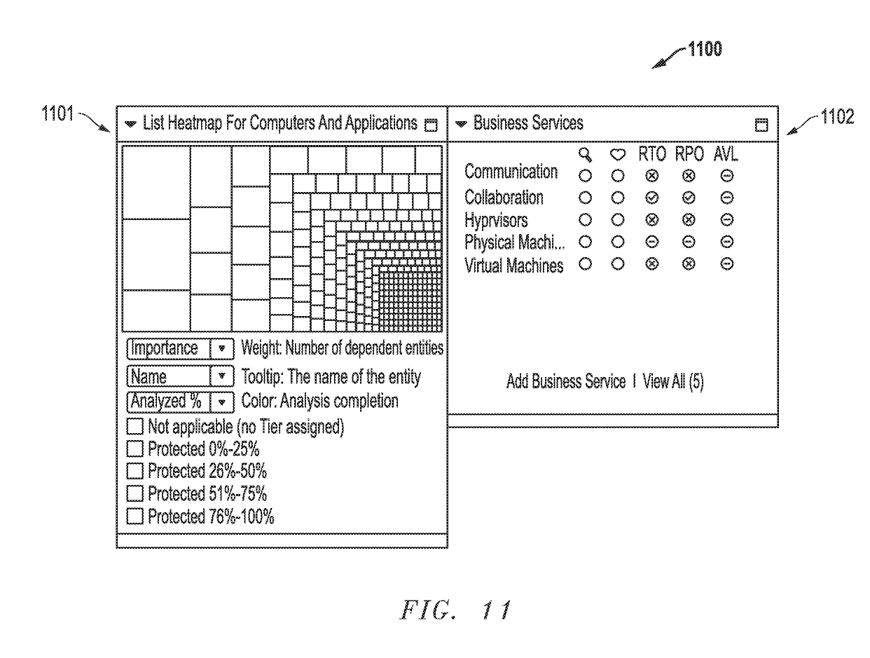

FIGS. 4A and 4B are depictions of one embodiment of the workflow of the present system for the automated infrastructure and dependency discovery module 400. Once the present computer implemented system and method is installed in a computer server, the system begins its discovery process that involves automated and agentless discovery of IT inventory and associated dependencies 401. The system also renders these discovered dependency relationships in visual dependency graphs and heat maps (show in FIGS. 7 and 11) that allow for intuitive and interactive comprehension 402. It can save hours of manual effort by automatically identifying IT infrastructure, applications and their dependency relationships. All information obtained during the discovery process is stored in the system's database pending further analysis. Information of interest includes (but is not limited to): networks, servers (both physical and virtual), hypervisors, operating systems, protection technologies, specific supported applications, generic applications, user devices and interdependencies among all of the above. Dependency analysis and discovery further comprises: algorithms for incremental analysis of dependencies with additional discovery functionality; determined client and server relationships using analysis of port usage; and credentialing for performing operations.

Business Services Mapping 403. The system allows business services to be defined based on underlying IT infrastructure dependencies and the resultant “footprint”. Consequently, the system helps you understand which IT components are the most important to the business, and how business services map to IT infrastructure.

Define Business Continuity Targets 404. The system allows business continuity and availability service level targets to be defined for each business service and immediately identify non-compliant components of the infrastructure. It provides at least four service level tiers that can be customized to define your own targets, then each business service is assigned to the appropriate tier. The system automatically reports on any gaps or misconfigurations of protection infrastructure. This notifies the user in advance if there are any gaps in its organization's protection strategy that put the business at risk.

Risk Identification Heat Maps 405. The system includes visual heat maps that highlight the most critical risks in an organization's infrastructure and allows the prioritization of remediation efforts. From the analysis of established availability service level tiers and the number of key dependencies, the system's heat maps show which servers are the most critical to business continuity. The visual map lets the user prioritize remediation efforts for systems that are out of compliance. Intuitive representation of infrastructure identifies the most critical IT components so what gaps to fix first may be prioritized.

Availability Monitoring and Reporting 406. The system provides continuous monitoring, assurance and reporting of availability service level compliance. By automating the discovery of new or updated IT infrastructure, the system dynamically ties changes to the impact on service level targets. This allows the user to proactively manage and report on business continuity preparedness and compliance. This allows the organization to know that the organization can meet business continuity commitments and keep the business online. Availability means the current ability to meet the business service's SLA based on historical monitoring across application and infrastructure available, RPO and RTO.

All information obtained during the discovery process is stored in the system's database pending further analysis 407. Information of interest includes (but is not limited to): networks, servers (both physical and virtual), hypervisors, operating systems, protection technologies, specific supported applications, generic applications, user devices and interdependencies among all of the above.

Credentials Management. The system secures communication of passwords between its (management) client plug-in (such as vSphere Web) and the system appliance using robust encryption. Furthermore all credentials (username, passwords, etc.) are stored in an encrypted format within the system's database. As such, all sensitive information captured by the system is secured.

Event-driven model module 407. The system's database is populated under user control as each discovered network is released for further profiling. In this way, the bulk of the computer automated discovery takes place in the days following the system's deployment. However, the system has been designed around an event-driven model module that allows its database to be updated in real-time as changes occur within the IT computer system's infrastructure. The key benefit of using an event-driven model is that it allows the system's disaster recovery assurance functionality to alert users immediately to any change within the infrastructure that could compromise the availability of key services within service level targets.

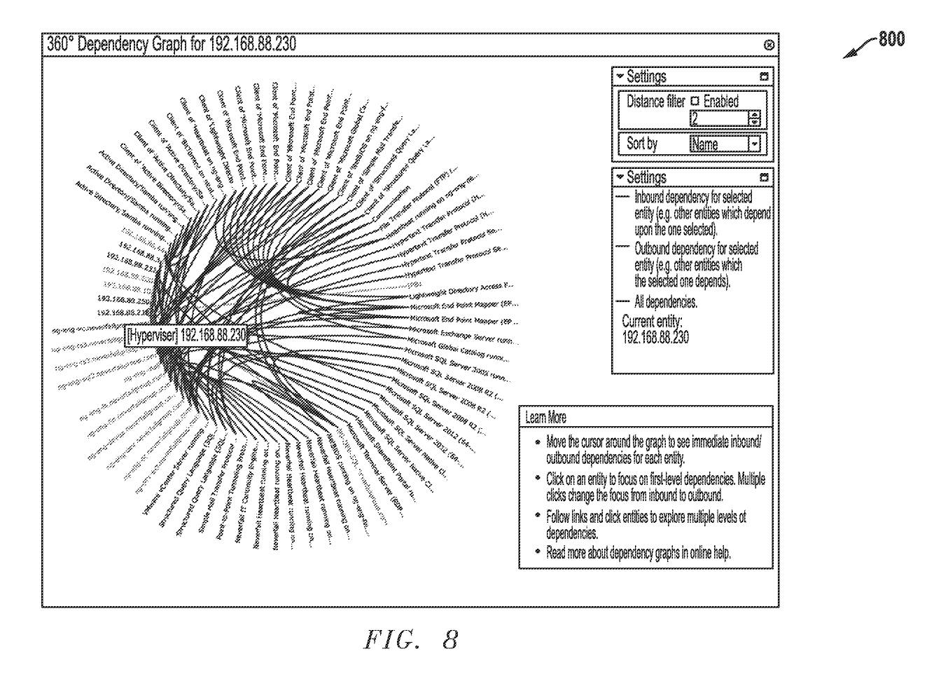

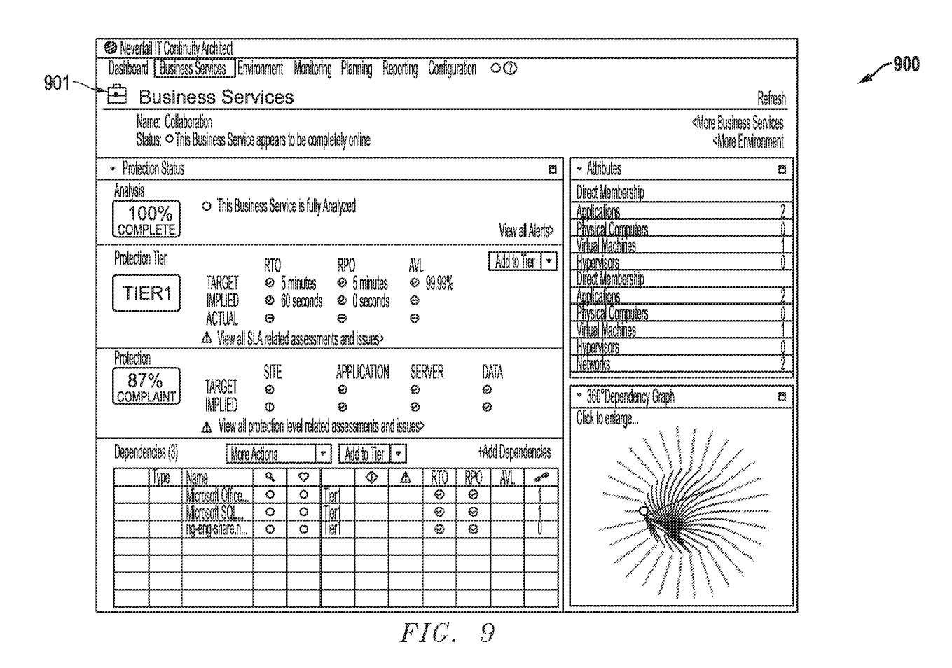

Turning now to FIG. 4B, the system workflow 415, all initial discovery activity takes place automatically by the system running in the background following deployment (download, deploy, register and auto discovery infrastructure and dependencies) 416, 417. The user intervenes only to release discovered networks or provide credentials to specific systems for further profiling and blueprinting by the system. While the system does not impose any specific workflow, an exemplary process is set forth in FIG. 4. In the explore and analyze results steps 418, the system offers automated software intuitive tools to explore and analyze the results of discovery. The system's automated dependency graph allows easy exploration of interdependencies. Questions such as “which VMs use this SQL database”, or “which applications consume this web service” are quickly answered. The dependency graph is shown below in FIG. 8. The system also provides detailed information for each analyzed entity showing core attributes and protection status. In order to obtain a complete perspective of the IT infrastructure and assess overall protection status, users may define a set of business services (e.g. the “email” service) as documented in the suggested workflow in FIG. 4B 419. Next, after associating the business service with the relevant dependent IT infrastructure, users can apply a protection tier to the entire service or this can be done automatically by the system 420, inclusive of the business service just created and all of its dependencies, thereby obtaining an assessment on aggregate protection status 421. In the create business services over infrastructure step of the workflow 419, a business service is an aggregation of IT hardware and software components that ultimately supports a discrete function that both business and IT user will readily understand (e.g. payroll, order processing). The system was designed around this concept because negotiating service level agreements at the level of individual IT components is too complex and therefore meaningless to users. For example, a user will certainly agree that they use “email” and they will most likely demand Tier 1 protection status for such a critical service, but they are disinterested in the minutia of what IT services collaborate to deliver “email”. By contrast, I & O professionals are very interested in making sure that all of these collaborating IT services that deliver “email” are adequately protected so that email is always available. The system provides a view of each business service that shows its dependent IT components (shown in FIG. 9). The system reports on the overall risk exposure of the networked computer forming the computer information technology infrastructure 422, performs model mitigations and solutions to mitigate those risks 423 and monitors for new risks against policy baselines and reacts to those new risks 424.

FIG. 5 is a diagram 500 representative of the discovery 501, fingerprinting 502 and blueprinting process 503. Discovery means finds out about all IP addresses of the networked computers and other devices and tracking the relationship of the IP addresses to an IP device. A single device can have multiple IP addresses. Fingerprinting means finding out what kind of device (IP device) the IP address represents (i.e. is it a printer, a printer router, a computer server with a Windows or Linux operating system). Blueprinting means a process wherein based on the fingerprint information, specific details are gathered regarding the IP device and its installed software applications, protection provisions and dependencies. As shown in FIG. 5, the discovery phase uses active network scanning and passive packet sniffing to identify further networks beyond the system's “host network”. In the discovery and fingerprinting processes, network technology protocols such as address resolution protocol (ARP), Internet control message protocol (ICMP), simple network management protocol (SNMP) and the like may be used to perform some or all of the following functions: converting an IP address to a physical address such as an Ethernet address, resolving network layer addresses into link layer addresses, using ICMP messages for diagnostic purposes, managing devices on the IP network, and discovering installed applications remotely. Newly discovered networks are queued for fingerprinting analysis but only when and if instructed to do so by the user. This phase also identifies IP addresses and ports of interest within given IP ranges for each network that is analyzed. The fingerprinting phase profiles each IP address of interest to differentiate routers, switches, desktops, servers and hypervisors. Scope may be restricted to just those networks that have been enabled for discovery. As part of fingerprinting, the system and method discovers more granular information such as server name and installed operating system. In the blueprinting phase, the system and method run scripts or exercise APIs on each server remotely. These scripts analyze all active connections between the profiled server and other entities on the network. Together with port analysis, this process enables the system's user to easily associate a set of collaborating IT objects with a defined business service. The impact of the systems' activities on the environments being profiled is minimized. This may be accomplished in part by implementing discovery as an agentless activity to minimize management overhead. Furthermore, discovery activity is throttled to minimize impact on the network. What is meant by the throttling process is that the rate at which an application processing occurs in the applicable computer processor is regulated either statically or dynamically.

Agentless discovery and fingerprinting further comprises algorithms produced for adaptive use of security scanners (for example Network Mapper (NMAP)) for discovery and fingerprinting (for example ARP, SMB protocol analysis, and ICMP scanning); verifying behavior against all physical and virtual computer servers (for example, Windows servers, ESX virtual servers and Linux servers); no requirement of credentials with a high-probability of successful discovery/fingerprinting; using; using intrusion detection systems (IDS) to understand the network impact and security impact; performance characteristics; packet sniffing technology and techniques surveys; and deep packet analysis for advanced discovery and dependency analysis.

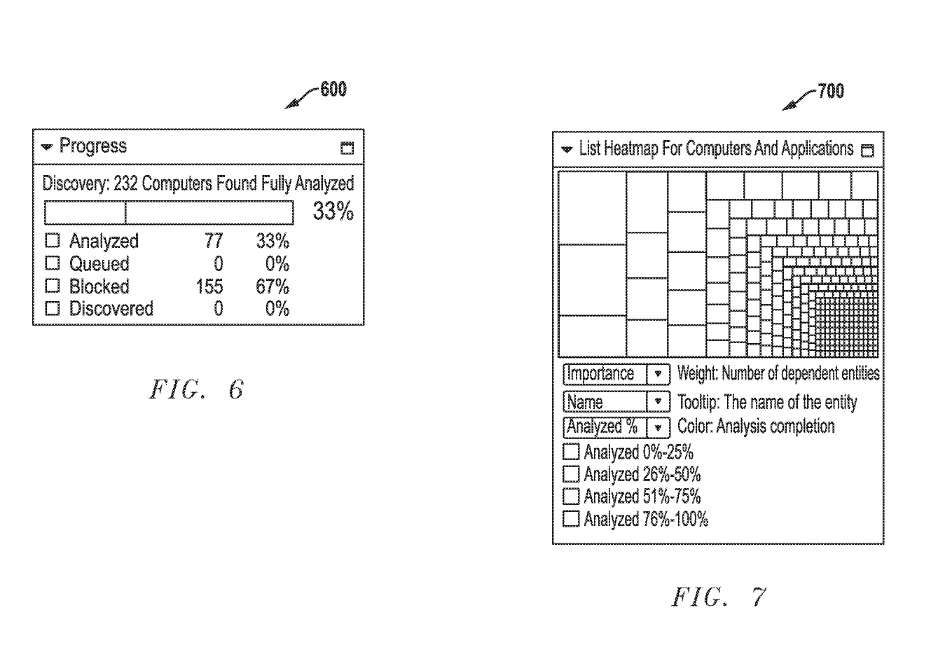

FIG. 6 is a depiction of one embodiment of the graphical user interface rendering of the status of discovery and analysis of the present system 600. Throughout the discovery process, progress is displayed in a portlet user interface within the system's user interface management function. The user interface platform may be a web client, having a plugin architecture, data access application programming interface (API), extension points, support java services and a framework such as a model-view-controller (MVC) framework, and allow for third party software application plugins.

FIG. 7 is a depiction of one embodiment of the graphical user interface heatmap of the present system 700. It shows a “heat map” that visually depicts parts of the system that may have discovery analysis blocked because of security credentials. The heat may reflect the results of a security analysis that determined the minimum privileges and security credentials that are needed for remote execution of scripts. The heat map helps users prioritize efforts to provide credentials for blocked servers. The larger the size of a rectangle in the display, the more infrastructure and number of dependent entities that the particular entity supports. In this particular context, each box on the heat map represents a blocked entity. Users can simply click on the largest boxes to drill down to a more detailed view, browse the alerts related to that entity to see the reason for the blockage and then take action based on the advisory note included. Required actions may be to add more credentials, add network routes or open ports on servers or firewalls.

FIG. 8 is a depiction of an exemplary system dependency graph of the present system 800. The system also provides detailed information for each analyzed entity showing core attributes and protection status. In order to obtain a complete perspective of the IT infrastructure and assess overall protection status, users may define a set of business services (e.g. the “email” service) as documented in the suggested workflow above in FIG. 4. Next, after associating the business service with the relevant dependent IT infrastructure, users can apply a protection tier to the entire service, inclusive of the business service just created and all of its dependencies, thereby obtaining an assessment on aggregate protection status.

FIG. 9 is a depiction of a user interface of an exemplary business service of the present system 900. In FIG. 9, a finance business service is shown. Business services 901 can be created and populated with dependent IT components very easily. The system's dependency mapping makes it easy to create business services and link the relevant IT assets to them. In this example, there are at least two approaches to creating a business service within the system. A top-down approach by identifying a specific application (for example a Microsoft SharePoint server) and then using the system's dependency mapping features to automatically identify all the connected infrastructure components to load into for example, the “Document Management” business service. A bottom-up approach by choosing the database server (or VM) for the relevant service (e.g. the Microsoft SQL database instance that's used for SharePoint), then following all dependencies up the infrastructure stack to load into the business service. In either case, the relevant infrastructure supporting the relevant service instance is identified and classified as part of the “Document Management” business service.

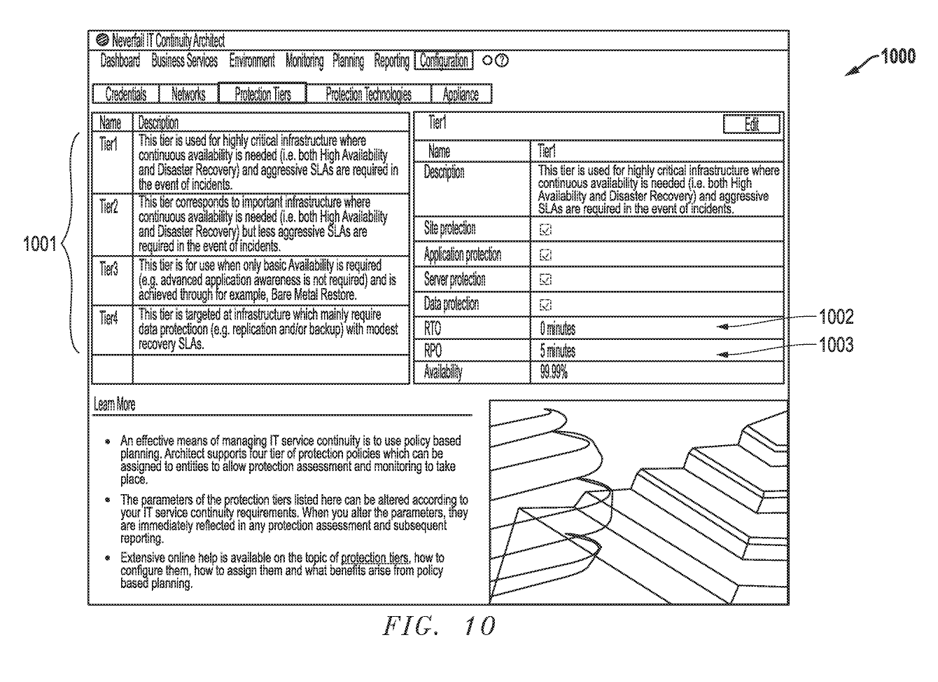

FIG. 10 is a depiction of a user interface of an exemplary protection tier settings display 1000. In the assigning protection assessments against policy step of the workflow depicted in FIGS. 4A and 4B, once a business service has been defined and populated with dependent IT assets, the next step is for a business user to determine an appropriate service level as defined by one of the protection tiers offered within the automated system. Each protection tier comes with default settings that may be overridden to reflect custom settings most appropriate and relevant to a specific IT environment. These settings define the scope of protection (i.e. data protection or backup, high availability protection against application or server failures, disaster recovery protection against site failures) and performance of protection (i.e. availability targets, RTO 1002, RPO 1003), as shown in FIG. 10.

Once the system is configured, the user may assign the appropriate protection tier to any given business service or this can be done automatically by the system 1001. The system performs analysis on each dependent IT component within the business service. It applies its knowledge of the deployed protection infrastructure for each component to determine whether or not it will meet the required service level agreement (as set out in the protection tier).

As an example, an email service has three possible scenarios. In a first scenario, the protection tier calls for protection to a disaster recovery site with a recovery point objective of 120 minutes for the “email” service (i.e. no more than 120 minutes worth of email will be lost during a failover to the disaster recovery site). The system sees that service replication has been deployed on a server VM (such as a Microsoft Exchange server) and has been configured to replicate changed VM blocks every 60 minutes. In this instance, the system would report a green status for the server.

If the protection tier 1001 for “email” calls for a recovery point objective of 30 minutes, the system would report an amber status for the server. This means that “email” would not meet its service level target of 30 minutes because replication takes place every 60 minutes. But the system automatically knows that the server VM replication could be configured to meet the given target and will report status as amber because with a simple configuration change to the server VM replication, service levels can be met.

In a third scenario, if the protection 1001 tier calls for a 5 minute recovery point objective. The system would report a red status for the server VM, because the system automatically knows that the chosen protection strategy, in this case server VM replication, is incapable of meeting this target under any circumstances.

Disaster recovery assurance status may be reported in multiple places: within a system dashboard highlighting overall health of key business services; in the detailed view for each business service (FIG. 9); in the heat map view showing the protection assessment (FIG. 11); or in the protection assessment report page 1000. All of these statuses are maintained in the system's database and may be depicted to a user via displays generated by the user interface management function.

FIG. 11 shows the protection assessment that is a visual depiction of exemplary health summary of the status of the IT continuity infrastructure 1100. Each box in the heat map 1101 represents a dependent entity within a given business service 1102. The heat map 1101 is designed to help the user prioritize their remediation efforts. A complex business service 1102 may comprise many dependent entities and the size of each box within the heat map is directly proportional to the number of dependencies associated with that entity. The “heat” color scheme associated with these boxes 1101 as indicated in FIG. 11 is representative of how adequately protected or not a given entity is. As such, a large box within the heat map displaying prominent red color in most cases would be indicating that one of the more critical entities within the IT environment is at risk possibly due to inadequate protection. By drilling down into the large red boxes (double-click action) in the heat map view, the administrator can focus remediation efforts on the most critical components.

The system can analyze and report on protection for known third party applications. For lesser known third party applications, they may be profiled within the system's continuity database to set up recovery scope and performance characteristics. This will enable basic protection assessment analysis to take place.

In the continuous monitoring for disaster recovery step (FIG. 4, 406), once protection tiers have been assigned to business services 1102, the system knows what recovery point (FIG. 10, 1002), recovery time (FIG. 10, 1003) and availability service levels are expected from the infrastructure “footprint” of that business service. The system provides separate monitoring services to assure the continued operation of an organization's business services within the parameters of these service level agreement (SLAs) and proactively advise of any looming risks before they become an issue.

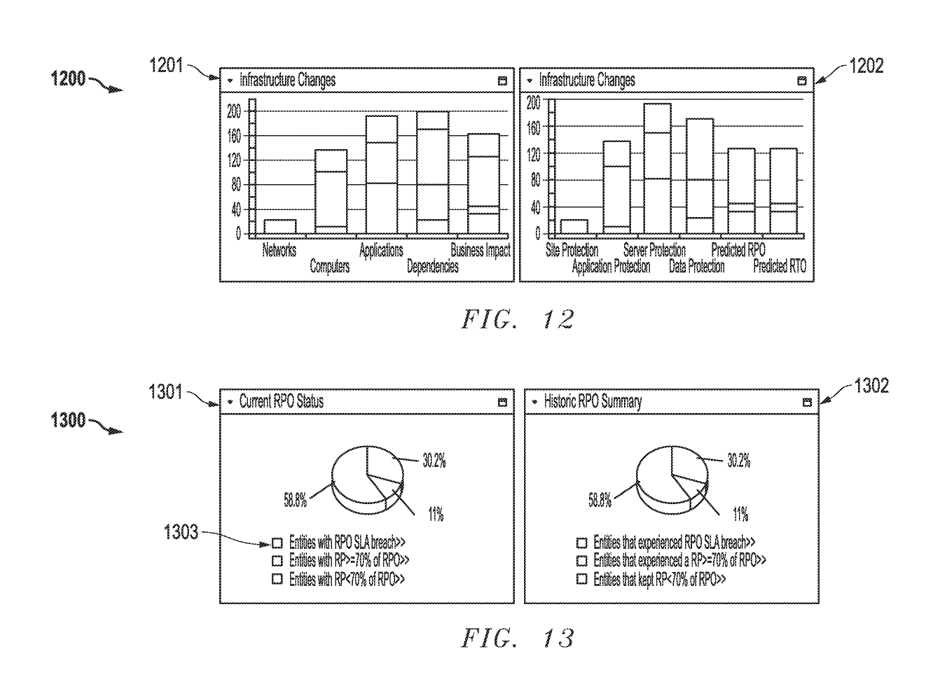

FIG. 12 is a visual depiction of a user interface showing exemplary infrastructure change monitoring functionality of the present system 1200. If a business service is protected in line with its assigned tier, administrators and end-users will want to know of any changes which might compromise that situation. The system will monitor for any changes in the configuration of protection technologies that reduces protection levels and puts the business service at risk such as infrastructure changes 1201 or protection assessment changes 1202. For example, if a VM inadvertently had high availability switched off, was removed from a site recovery manager protection group, or had a VM service replication RPO increased, the system will detect these changes, evaluate them against the assigned SLA targets and raise alerts if new levels of risk have been introduced. This form of monitoring will take place for all supported protection technologies. Furthermore, if a business service grows its “footprint” over time to include new dependencies, either applications or servers, then the system will automatically detect these new dependencies and alert administrators to the risk and the need to review the new infrastructure.

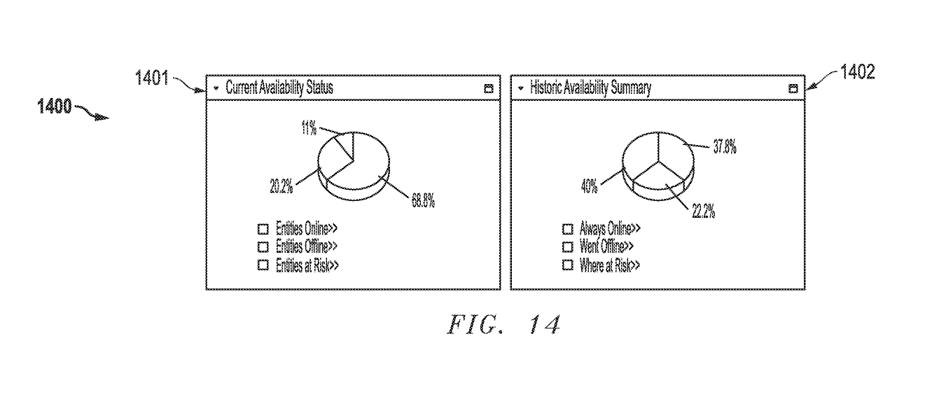

FIG. 13 is a visual depiction of a user interface showing exemplary recovery point monitoring functionality of the present system 1300. Most organizations will include data protection as a policy requirement in their assigned tier with an associated recovery point objective (RPO) 1301 service level agreement (SLA) 1303. Data protection often relies on replication technologies. The achievable RPO for replication technology varies depending on a number of environmental issues including host, guest and network load. It is not uncommon for replication to falter to the extent that the actual RPO is far worse than required and should disaster strike the recovery will fail to meet the expected SLAs. The historic RPO is also displayed to the user 1302. The system is able to monitor the achievable recovery point—the recovery point estimate (RPE)—in real-time. Warning alerts are generated if the RPE rises above a configurable threshold and critical alerts are generated if the RPO SLA is breeched.

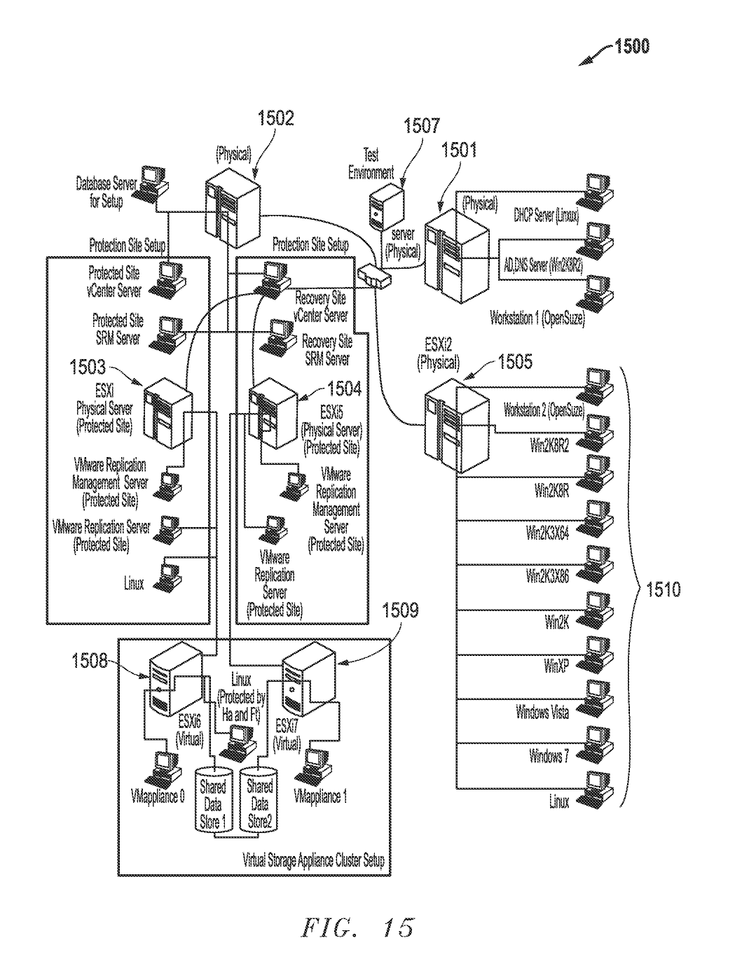

FIG. 14 is a visual depiction of a user interface showing exemplary availability monitoring functionality of the present system 1400. The system provides a predicted assessment of how likely it is that the detected protection technologies will support the assigned availability tiers. Administrators and end-users who have funded and implemented these solutions will want to know whether in fact these technologies actually deliver on the expected availability SLAs. The system provides ongoing monitoring of all business services, applications and servers that have a tier assigned to evaluate how well their availability matches requirements. Furthermore, the system monitors and evaluates availability across dependency relationships so it can even detect when an outage of a modestly used server may have a “ripple effect” impact on the overall availability of an entire business service. Availability is tracked and reported upon relative to the rigors of the assigned tier 1401. Any accumulated unplanned downtime which breaches a tiers SLA is announced as an alert. The system also reports on the historical availability of all tier assigned infrastructure over any point in time 1402.

FIG. 15 depicts an alternative embodiment of a computer system and network suitable for implementing the system and method for ensuring computer information technology infrastructure continuity 1500. In FIG. 15, the computer devices are a mixture of physical machines 1501-1507 and virtual machines 1508, 1509 running Windows and Linux based operating systems. The servers may be protected by site recovery management software applications or the like. The servers may use software applications for allowing virtualization of servers, storage and networks, allowing multiple software applications to run in virtual machines on the same physical servers. User interfaces 1510 may be present. Security software tools may be present on the physical machines 1501-1507 and virtual machines 1508, 1509 such as intrusion detection systems for asset discovery, vulnerability assessment, threat detection and behavioral monitoring.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

As used herein a server is a system (computer software and suitable computer hardware having a software operating system) that responds to requests across a computer network to provide, or help to provide, a network service. Servers can be run on a dedicated computer, which is also often referred to as “the server”, but many networked computers are capable of hosting servers. In many cases, a computer can provide several services and have several servers running. Servers are comprised of at least a computer processor and memory. Servers operate within a client-server architecture; servers may be computer programs running to serve the requests of other programs, the clients. Thus, the server performs some task on behalf of clients. The clients typically connect to the server through the network but may run on the same computer. In the context of Internet Protocol (IP) networking, a server is a program that operates as a socket listener. Servers often provide essential services across a network, either to private users inside a large organization or to public users via the Internet. Typical computing servers are database server, file server, mail server, print server, web server, gaming server, application server, or some other kind of server. Numerous systems use this client and server networking model including Web sites and email services. An alternative model, peer-to-peer networking enables all computers to act as either a server or client as needed. The term server is used quite broadly in information technology. Despite the many server-branded products available (such as server versions of hardware, software or operating systems), in theory any computerized process that shares a resource to one or more client processes is a server. To illustrate this, take the common example of file sharing. While the existence of files on a machine does not classify it as a server, the mechanism which shares these files to clients by the operating system is the server.

Similarly, consider a web server application (such as the multiplatform “Apache HTTP Server”). This web server software can be run on any capable computer. For example, while a laptop or personal computer is not typically known as a server, they can in these situations fulfill the role of one, and hence be labeled as one. It is, in this case, the machine's role that places it in the category of server. In the hardware sense, the word server typically designates computer models intended for hosting software applications under the heavy demand of a network environment. In this client-server configuration one or more machines, either a computer or a computer appliance, share information with each other with one acting as a host for the others.

Computer systems have traditionally consisted of physical machines (for example, physical computer servers). Virtual machines are software simulations of the hardware components of a physical machine. Although a physical machine host is required for implementation of one or more virtual machines, virtualization permits consolidation of computing resources otherwise distributed across multiple physical machines to fewer or even a single host physical machine. The consolidation enables reductions in space, power, cooling, and hardware requirements. A virtual machine can be moved between physical machines to balance workloads, utilize faster physical machines, or to recover from a hardware fault on a physical machine. The benefits of virtualization have resulted in the development of virtual machine management software and system tools. One limitation of prior art virtual machine management tools is a lack of support for managing physical machines. Another limitation is the lack of variety of virtualization platforms that are supported on a single virtual machine management software and system tool. While the use of virtualization can lead to reductions in the cost of deploying and managing computers, the inability to use the same management tool to manage all of the individual machines forming the computer system as a whole tends to increase the cost and complexity of managing the system as a whole. The networked computers may be physical server computers or virtual machines. Alternatively, the networked computers may be physical workstations such as personal computers, or a mixture of servers and workstations. The servers may be, for example, SQL servers, Web servers, Microsoft Exchange servers, Linux servers, Lotus Notes servers (or any other application server), file servers, print servers, or any type of server that requires recovery should a failure occur. Most preferably, each protected server computer runs a network operating system such as Windows or Linux or the like. The computer network may be an Internet network or a local area network (LAN). The network may be implemented as an Ethernet, a token ring, other local area net protocol or any other network technology, such network technology being known to those skilled in the art. The network may be a simple topography, or a composite network including such bridges, routers and other network devices as may be required.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A computer system apparatus for providing continuity of a computer information technology infrastructure comprising:
a plurality of networked computers forming the computer information technology infrastructure and communicatively coupled to the computer system apparatus, each computer having a computer processor, memory and storage;
a server having a computer processor coupled to a memory wherein the computer processor is programmed to provide continuity of the computer information technology infrastructure by:
an infrastructure inventory and dependency discovery module that analyzes the networked computers and maps interdependencies among the networked computers;
a business services mapping module that aggregates the networked computers into business services based on their interdependencies;
a business continuity target module that assigns each business service to a service level tier and reports on gaps in protection of each business service;
a risk identification module that identifies the networked computers in the computer technology infrastructure and prioritizes the networked computers by criticality of the networked computer to the computer technology infrastructure business continuity and generates a risk profile; and
an availability infrastructure change monitoring and reporting module that provides continuous monitoring and reporting of the status of the networked computers and tracks any changes in the status.

2. The computer system apparatus of claim 1 further comprises a service level monitoring and reporting module that includes a recovery time objective that represents allowable downtime for the networked computers.

3. The computer system apparatus of claim 1 further comprises a service level monitoring and reporting module that includes a recovery point objective that represents the amount of data loss tolerable for the networked computers.

4. The computer system apparatus of claim 1 wherein the apparatus is a virtual machine.

5. The computer system apparatus of claim 1 wherein the apparatus is a physical machine.

6. The computer system apparatus of claim 1 wherein the apparatus comprises a virtual machine and a physical machine.

7. The computer system apparatus of claim 1 wherein the infrastructure inventory and dependency discovery module that analyzes the networked computers and maps interdependencies among the networked computers maps the dependencies between computer software applications, hypervisors, physical computer servers, virtual computer servers, storage and networks.

8. The computer system apparatus of claim 1 wherein the business continuity target module that assigns each business service to a service level tier and reports on gaps in protection of each business service comprises providing service level tiers that can be automatically assigned to each business service.

9. The computer system apparatus of claim 1 wherein the risk identification module generates a risk profile visual display that displays the prioritized remediation that identifies the networked computers in the computer technology infrastructure and prioritizes the networked computers by their criticality to the computer technology infrastructure business continuity.

10. The computer system apparatus of claim 9 wherein the risk profile visual display is in the form of a heat map showing the networked computers and applications criticality to business continuity.

11. The computer system apparatus of claim 1 further comprising an event-driven module coupled to data storage wherein the event-drive module alerts users in real-time of any change to the networked computers forming the computer information technology infrastructure.

12. The computer system apparatus of claim 1 wherein the discovery module analyzes and maps all networked devices.

13. The computer system apparatus of claim 1, wherein the discovery module is an agentless algorithm.

14. The computer system apparatus of claim 13 wherein the discovery module comprises:
an IP discovery module that finds all the IP addresses of the networked computers;
a fingerprinting module that determines:
a type of IP device the IP address represents;
operating system profile;
the dependencies between a first IP device and at least a second IP device; and
a blueprinting module that interfaces with each IP device to analyze all connections among the first IP device and the second IP device including:
the installed software applications on IP device;
the protection provisos applicable to the IP device;

15. The computer system apparatus of claim 1 further comprising using web-services to conduct:
discovery dependency analysis of applications running on the networked computer;
application fingerprinting of the applications running on the networked computer;
blueprinting and modeling of the applications running on the networked computer;
monitoring the applications and identifying any protection issues for the application;
managing credentials for the discovery module;
managing a user interface;
managing the applications; and
reporting and alerting functions.

16. A computer program product for providing continuity of a computer information technology infrastructure comprising, the computer program product comprising:
a non-transitory computer readable storage medium having computer usable program code embodied herewith, the computer usable program code comprising:
computer usable program code configured to access and analyze networked computers and map interdependencies among the networked computers and inventory and discovery the interdependencies;
computer usable program code configured to aggregate the networked computers into business services based on their interdependencies and provide a mapping of the business services;
computer usable program code configured to assign each business service to a service level tier and reports on gaps in protection of each business service;
computer usable program code configured to identify the networked computers in the computer technology infrastructure and prioritize the networked computers by criticality of the networked computer to the computer technology infrastructure business continuity and generate a risk profile; and
computer usable program code configured to provides continuous monitoring and reporting of the status of the networked computers.

17. The computer program product set forth in claim 16 further comprising computer usable program code to monitor and report a recovery time objective that represents allowable downtime for the networked computers.

18. The computer program product set forth in claim 16 further comprising computer usable program code to monitor and report a recovery point objective that represents the amount of data loss tolerable for the networked computers.

19. The computer program product set forth in claim 16 wherein computer usable instructions are processed by a server selected from the group consisting of a virtual machine and a physical machine.

20. The computer program product of claim 16 further comprising web-services computer usable program code configured to conduct:
discovery dependency analysis of applications running on the networked computer;
application fingerprinting of the applications running on the networked computer;
blueprinting and modeling of the applications running on the networked computer;
monitoring the applications and identifying any protection issues for the application;
managing credentials for the discovery module;
managing a user interface;
managing the applications; and
reporting and alerting functions.
